(19) United States
(12) Patent Application Publication
(10) Pub. No.: US 2024/0104606 A1
(43) Pub. Date: Mar. 28, 2024

(54) APPARATUS AND METHODS FOR COLLABORATIVE ADVERTISING AND MARKETING CAMPAIGNS

(71) Applicant: Cosmo Moshe Grill

(72) Inventor: Cosmo Moshe Grill

(21) Appl. No.: 17/955,104

(22) Filed: Sep. 28, 2022

(51) Int. Cl. G06Q 30/02; G06Q 10/10

(52) U.S. Cl. CPC G06Q 30/0276; G06Q 10/101; G06Q 30/0277

(57) ABSTRACT

An apparatus and methods are provided for advertising partnership campaigns. The advertising partnership campaign attracts partnering brands to participate in brand partnership campaigns. The brand partnership campaign advertises and hosts a micro-store that includes a combination of products from all the participating partnering brands. Advertising content is developed, managed, and optimized across a variety of popular online advertising placements. The brand partnership campaign identifies and contracts content creators, creative directors, or production studios to develop the advertising content. Data and analytics about the performance of the brand partnership campaign are collected and compiled into performance reports. Analytics are reported to each partnering brand about the performance of its portion of the brand partnership campaign until the campaign concludes.

### FIELD

Embodiments of the present disclosure generally relate to advertising and marketing. More specifically, embodiments of the disclosure relate to an apparatus and methods for collaborative digital advertising and marketing campaigns.

### BACKGROUND

When manufacturers, venders, retailers, service providers, and the like (hereinafter, “brands”) want to advertise merchandise, they typically buy their own ads with their own brand only. Generally, such brands have their own advertising agency and media buyers, or they spend directly on advertising platforms. Brands typically send traffic to their own website. In some instances, a brand may partner with one or more other brands to form a brand partnership campaign. However, such brand partnership campaign typically are performed without paid media or digital marketing. Instead, brand partnership campaign typically are done organically or outside of the real-time digital advertising market.

A drawback to conventional brand partnership campaigns is that when the brand partners buy digital advertisement to boost their brand partnership campaigns, the brand partners run into transparency issues that are confusing. For example, when brand partners purchase digital ads, the brand partners may be confused about which partner is running the ads and which partner is reporting about the effectiveness of the ads. Partnering brands may become confused about how to view ad-related data pertaining to other partnering brands. Further, stakeholders aren't neutral so they will tend to optimize towards their own brand's performance rather than equally across the other partnering brands.

Another drawback to conventional brand partnership campaigns is that partnering brands may be confused about which brand is in charge of vetting brand partners and which partner brand will be defining the objectives of the brand partnership campaign. Other sources of confusion often include determining which brand is in charge of developing the creative for the brand partnership campaign, as well as determining which partner brand is in control of funding issues such as which brand partner will accept money and spend the money appropriately and which brand partner will oversee how the money is spent.

In general, conventional brand partnership campaigns are difficult because each brand partner has their own media managers, advertising accounts, and website—and also each brand will have different digital ad optimization objectives. What is needed, therefore, is an apparatus and methods for collaborative digital advertising and marketing campaigns wherein a mediating, neutral party orchestrates a multi-brand campaign that's powered with advertising and real-time ad optimization.

### SUMMARY

An apparatus and methods are provided for advertising partnership campaigns. The advertising partnership campaign attracts partnering brands to participate in brand partnership campaigns. The brand partnership campaign advertises and hosts a micro-store that includes a combination of products from all the participating partnering brands. Advertising content is developed, managed, and optimized across a variety of popular online advertising placements. The brand partnership campaign identifies and contracts content creators, creative directors, or production studios to develop the advertising content. Data and analytics about the performance of the brand partnership campaign are collected and compiled into performance reports. Analytics are reported to each partnering brand about the performance of its portion of the brand partnership campaign until the campaign concludes.

In an exemplary embodiment, a brand-specific advertising and marketing platform comprises: a campaign server system comprising a non-transient machine-readable medium and at least one processor; an advertising partnership platform stored on a memory of the campaign server system for operating a brand partnership campaign; an interface for providing access to partnering brands participating in the brand partnership campaign; a database for storing information pertaining to the brand partnership campaign and the partnering brands; and a suite of brand-specific components providing partnering brands interactivity with the brand partnership campaign.

In another exemplary embodiment, the brand-specific components comprise modules whereby each partnering brand may access and participate in the brand partnership campaign. In another exemplary embodiment, the brand-specific components include any one or more of a landing page, a dashboard, performance reports, advertising placements, and a micro-store. In another exemplary embodiment, the micro-store comprises a shared landing page that includes a combination of the products from all the participating partnering brands. In another exemplary embodiment, the landing page comprises a page that is specific to each partnering brand and enables the partnering brand to view and interact with its portion of the brand partnership campaign. In another exemplary embodiment, the dashboard comprises a graphical user interface whereby each partnering brand can view and access analytics pertaining to the performance of the brand partnership campaign.

In an exemplary embodiment, a process for managing a collaborative advertising and marketing campaign comprises: attracting partnering brands to participate in a brand partnership campaign; developing advertising content; creating a shared landing page; collecting funds from the partnering brands; producing reports with partnering brands; and concluding the brand partnership campaign.

In another exemplary embodiment, attracting the partnering brands includes posting a campaign brief directed to one or more product types that may be advertised by way of the brand partnership campaign. In another exemplary embodiment, developing advertising content includes producing and testing of advertising content pertaining to the brand partnership campaign. In another exemplary embodiment, developing advertising content includes identifying and contracting any one or more of a content creator, a creative director, and a production studio to develop advertising content for the campaign. In another exemplary embodiment, developing advertising content includes managing and optimizing advertising content across a variety of popular online advertising placements.

In another exemplary embodiment, creating a shared landing page comprises creating a micro-store that includes a combination of the products from all the partnering brands. In another exemplary embodiment, creating a shared landing page further includes developing a brand-specific page directed to each of the partnering brands. In another exemplary embodiment, producing reports includes providing a dashboard to each partnering brand. In another exemplary embodiment, providing the dashboard includes configuring the dashboard to report to the partnering brand on the performance of its portion of the brand partnership campaign. In another exemplary embodiment, configuring the dashboard includes collecting and compiling analytics to report to the partnering brands.

In another exemplary embodiment, collecting funds includes directing the partnering brands to make equal payments for the operation of the brand partnership campaign. In another exemplary embodiment, collecting funds includes retaining a small fee for the operation of the brand partnership campaign. In another exemplary embodiment, retaining the small fee includes directing remaining funds toward operating the brand partnership campaign. In another exemplary embodiment, directing the remaining funds includes budgeting funding for advertising development and online advertising placements.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 is a schematic illustrating an exemplary embodiment of a collaborative advertising and marketing process, according to the present disclosure;

FIG. 2 is a schematic illustrating an exemplary embodiment of a brand-specific advertising platform, according to the present disclosure;

FIG. 3 illustrates process for managing a collaborative advertising and marketing campaign in accordance with the present disclosure; and

FIG. 4 is a block diagram illustrating an exemplary data processing system that may be used with embodiments of a collaborative advertising and marketing platform according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the apparatus and methods disclosed herein may be practiced without these specific details. In other instances, specific numeric references such as “first brand,” may be made. However, the specific numeric reference should not be interpreted as a literal sequential order but rather interpreted that the “first brand” is different than a “second brand.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In some instances, a brand may partner with one or more other brands to form a brand partnership campaign. Such brand partnership campaigns are difficult, however, because each brand partner has their own media managers, advertising accounts, and website—and also each brand will have different digital ad optimization objectives. Confusion generally abounds once the brand partners buy digital advertisement to boost their brand partnership campaigns. For example, when brand partners purchase digital ads, the brand partners may be confused about which partner is running the ads and which partner is reporting about the effectiveness of the ads. Partnering brands may become confused about how to view ad-related data pertaining to other partnering brands. Further, partnering brands may be confused about which brand is in charge of developing creative content for the brand partnership campaign, as well as determining which partner brand is in control of funding issues such as which brand partner will accept money and spend the money appropriately and which brand partner will oversee how the money is spent.

Embodiments presented herein provide an apparatus and methods for collaborative digital advertising and marketing campaigns wherein a mediating, neutral party orchestrates a multi-brand campaign that's powered with advertising and real-time ad optimization. In general, the neutral party is a trusted 3^{rd} party that provides a contract and rules for the brand partnership, co-marketing content creation, paid media management, shared landing pages, transparent reporting of ad-related data, and the like.

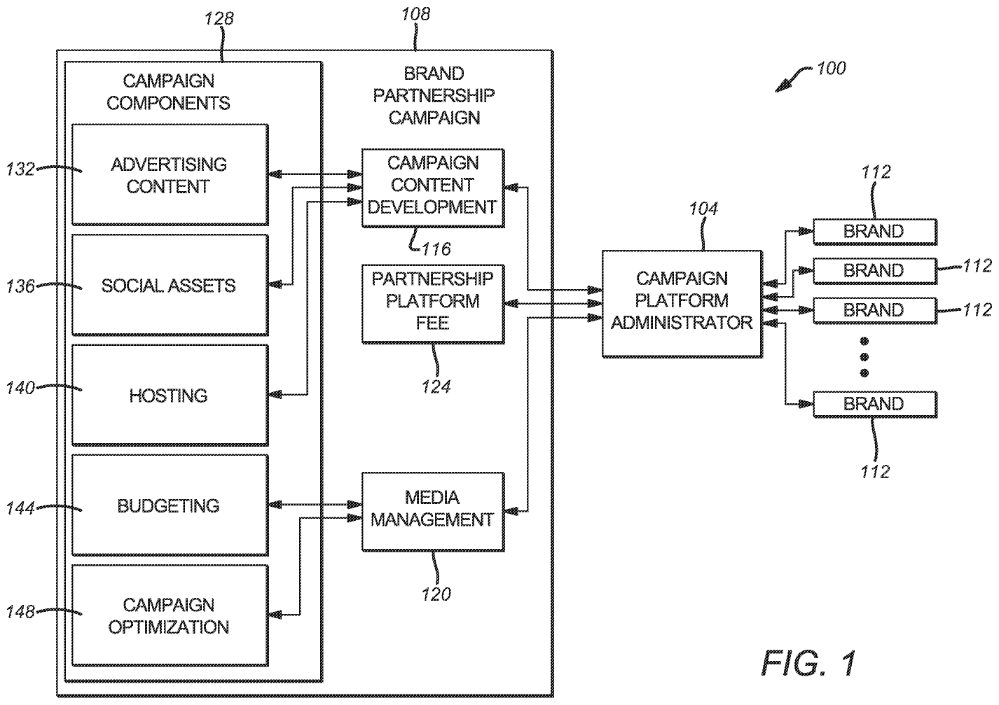

FIG. 1 is a schematic illustrating an exemplary embodiment of a collaborative advertising and marketing process 100, according to the present disclosure. In the process 100 of FIG. 1, a campaign platform administrator 104 orchestrates a brand partnership campaign 108 on behalf of multiple advertisers 112. As will be appreciated, each of the advertisers 112 comprises an entity desiring to advertise branded merchandise or services for sale. As such, each of the advertisers (hereinafter, “partnering brands”) 112 comprises any one or more of a manufacturer, a vender, a retailer, a service provider, and the like, without limitation. The campaign platform administrator 104 comprises the above-mentioned neutral, trusted 3^{rd} party that provides the contract/rules for the brand partnership, co-marketing content creation, paid media management, shared landing pages, transparent reporting of ad-related data, as described herein.

As shown in FIG. 1, the brand partnership campaign 108 comprises a campaign content development module 116, a media management module 120, and a partnership platform fee module 124 that are provided by the administrator 104 to the partnering brands 112. The modules 116, 120, 124 comprise services that the administrator 104 may perform on behalf of the partnering brands 112. As such, the partnering brands 112 share the cost of operating the brand partnership campaign 108 and consequently their brands will reach more potential customers due to combined media spending.

In one embodiment, for example, three partnering brands 112 can make equal payments, such as $10K each, to the administrator 104 to operate the brand partnership campaign 108. Thus, each of the partnering brands 112 will receive $30K worth of advertising exposure for a cost of $10K. It is contemplated that the advertising exposure will generally grow in direct proportion to the number of partnering brands 112 that join the campaign. Further, in some embodiments, the buy-in payment made by each partnering brand 112 may decrease in direction proportion to the number of partnering brands 112 joining the campaign.

Once the partnering brands 112 submit their payments, the administrator 104 can direct the partnership platform fee module 124 to charge a small fee, such as 10%, to operate the campaign. The remaining funds can be dedicated to operating the partnership campaign by way of the campaign content development module 116 and the media management module 120. For example, in one embodiment, 80% of the funds is directed to the media management module 120 while 10% of the funds is directed to the campaign content development module 116. In the above-mentioned embodiment, wherein the three partnering brands 112 each paid $10K, the administrator 104 can direct $24K to the media management module 120 and $3K to the campaign content development module 116. Other fee structures will be apparent to those skilled in the art.

In the embodiment shown in FIG. 1, the brand partnership campaign 108 includes campaign components 128 that may be directed or performed by the campaign content development module 116 and the media management module 120. In some embodiments, the campaign content development module 116 may manage the operation of an advertising content component 132, a social assets component 136, and a hosting component 140. The advertising content component 132 may include production and testing of advertising content pertaining to the brand partnership campaign 108. For example, in an embodiment, the advertising content component 132 may include identifying and contracting a content creator, a creative director, or a production studio to develop advertising content for the campaign. Further, the advertising content component 132 may manage and optimize advertising content across a variety of popular online advertising placements.

In some embodiments, the social assets component 136 may include developing and providing each of the partnering brands 112 with a dashboard and reports on the performance of the brand partnership campaign. The hosting component 140 may, in some embodiments, include developing and hosting a shared landing page for the partnering brands 112. The shared landing page may comprise a micro-store that includes a combination of the products pertaining to the brand partnership campaign 108. For example, in a brand partnership campaign 108 that is related to eco-friendly kitchen products, the micro-store may include a combination of eco-friendly kitchen products from all of the partnering brands 112. In general, the shared landing page may be a “neutral” page that features products from all the participating partnering brands 112. Further, the hosting component 140 may develop a brand-specific page that includes a dashboard. It is contemplated that the dashboard may be configured to report to each of the partnering brands 112 on the performance of their portion of the brand partnership campaign.

As shown in FIG. 1, the media management module 120 may manage the operation of a budgeting component 144 and a campaign optimization component 148. In some embodiments, the budgeting component 144 manages and directs funding for advertising development and placement. For example, the budgeting component 144 may optimize funding across popular search engines, online advertising placements, and sponsored newsletters, and the like. The campaign optimization component 148 may, in some embodiments, provide reporting and analytics to the partnering brands 112. The campaign optimization component 148 may collect and compile analytics to report to each of the partnering brands 112 on the performance of their portion of the brand partnership campaign 108.

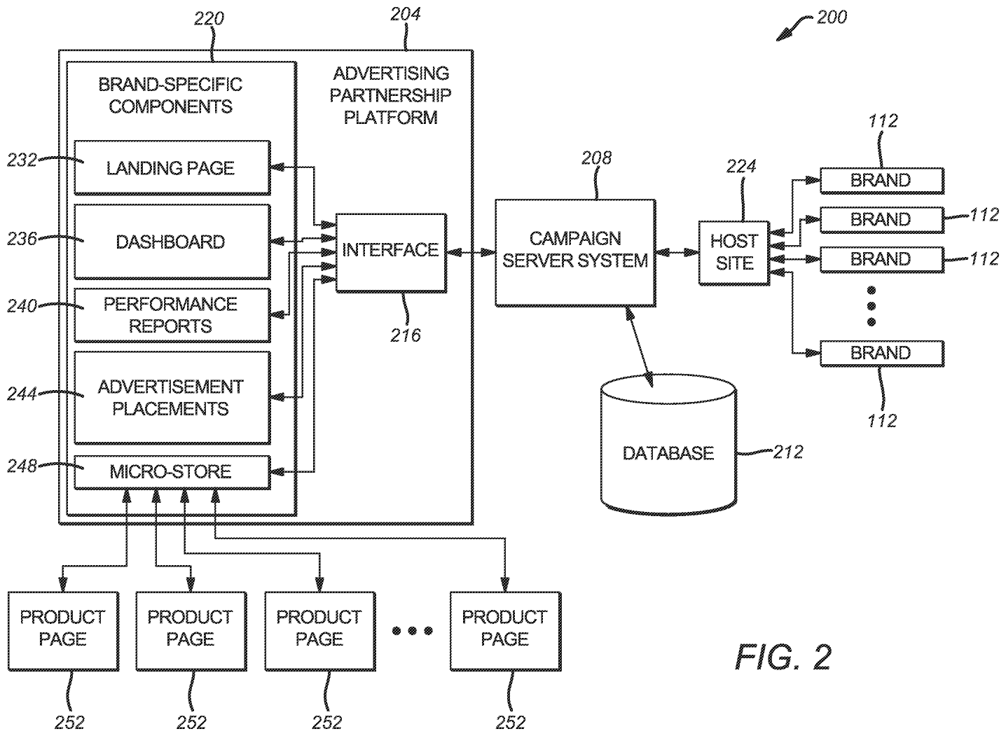

FIG. 2 is a schematic illustrating an exemplary embodiment of a brand-specific advertising and marketing platform 200 in accordance with the present disclosure. The platform 200 comprises an advertising partnership platform 204 that is provided and managed by a campaign server system 208. The advertising partnership platform 204 may be stored on a non-transient machine-readable medium (i.e., a memory) of the campaign server system 208 which comprises at least one processor and has connectivity to a database 212. Generally, the database 212 stores information pertaining to the brand partnership campaign 108 as well as the partnering brands 112. Further, the database 112 may store data and analytics pertaining to the performance of the brand partnership campaign 108. It is contemplated that the data stored on the database 112 may be used to develop reports to each of the partnering brands 112 on the performance of their portion of the brand partnership campaign 108.

In some embodiments, the advertising partnership platform 204 comprises an interface 216 that provides access to a brand-specific components suite 220. A host site 224 provides a multiplicity of partnering brands 112 access to the advertising partnership platform 204 by way of a communications network, such as the Internet. The partnering brands 112 comprise any of manufacturers, venders, retailers, service providers, and the like, desiring to access and interact with status and performance data relating to the brand partnership campaign 108. In some embodiments, the host site 224 comprises a web-based application by which the partnering brands 112 interact with the suite of brand-specific components 220. In some embodiments, the host site 224 may comprise a customized web-based mobile device application that enables partnering brands 112 to directly interact with the suite of brand-specific components 220. In some embodiments, the host site 224 and the advertising partnership platform 204 may comprise a software application configured to operate on a mobile device, such as a cellphone, and communicate with the database 212 by way of the campaign server system 208.

Preferably, each of the partnering brands 112 may utilize applications stored on the memory of the campaign server system 208 to interact with the suite of brand-specific components 220 so as to access data and analytics pertaining to the performance of the brand partnership campaign 108. In one embodiment, the suite of brand-specific components 220 is stored on the memory of the campaign server system 208, and the interface 216 is a software application that comprises a portion of the advertising partnership platform 204 that provides access to the suite of brand-specific components 220. In some embodiments, the suite of brand-specific components 220 may be services operated by one or more third-party service providers. In such embodiments, the interface 216 may comprise a connection over a communications network, such as an Internet connection, whereby the campaign server system 208 may send requests to, and receive services from, the one or more third-party service providers.

The brand-specific components 220 generally comprise component modules whereby each partnering brand 112 may access and interact with data and analytics pertaining to the performance of the brand partnership campaign 108. In the illustrated embodiment of FIG. 2, the brand-specific components 220 includes a landing page 232, a dashboard 236, performance reports 240, advertising placements 244, and a micro-store 248. In some embodiments, however, the suite of brand-specific components 220 may comprise other modules in addition to the components illustrated in FIG. 2, without limitation and without deviating beyond the spirt and scope of the present disclosure.

The landing page 232 may, in some embodiments, comprise a shared landing page that features products from all the participating partnering brands 112. In other embodiments, however, the landing page 232 may be specific to each partnering brand 112, and thus enable the partnering brand 112 to view and interact with its portion of the brand partnership campaign 108. In some embodiments, the landing page 232 may provide access comprise a micro-store that includes a combination of the products pertaining to the brand partnership campaign 108. As mentioned above, for example, in a brand partnership campaign 108 that is related to eco-friendly kitchen products, the micro-store may include a combination of eco-friendly kitchen products from all of the partnering brands 112. As such, the landing page 232 may provide the partnering brands 112 with access to a “neutral” page that features products from all the participating partnering brands 112.

The dashboard 236 may be configured to report to each of the partnering brands 112 on the performance of their portion of the brand partnership campaign 108. The dashboard 236 may comprise a graphical user interface whereby each partnering brand 112 may view and access data and analytics pertaining to the performance of the brand partnership campaign 108. The dashboard 236 may comprise one or more graphical elements, such as on-screen buttons, that are configured to commence the retrieval of campaign-related data from campaign server system 208 and/or the database 212. In some embodiments, the dashboard 236 may be configured to display the campaign-related data in the form of performance reports 240. Such performance reports 240 may utilize data stored on the database 112 to inform the partnering brands 112 about the performance of their portion of the brand partnership campaign 108.

Moreover, the dashboard 236 may be configured to display data and analytics pertaining to advertising placements 244. Data related to advertising placements 244 may be configured to display advertising performance data as a function of the placement of each advertisement. As will be appreciated, customer response to advertising content across a variety of advertising placements generally will vary. In some embodiments, the advertising placements 244 may be display campaign-performance data arising due to each advertising placement. As such, the advertising placements 244 generally enable partnering brands 112 to manage and optimize advertising content across a variety of popular online advertising placements.

The micro-store 248 comprises a shared landing page that includes a combination of the products from all of the partnering brands 112 pertaining to the brand partnership campaign 108. In some embodiments, the micro-store 248 may redirect customers to specific product pages 252 based on their selections in the micro-store 248. It is contemplated that each of the specific product pages 252 is related to one product that is listed among the many products included in the micro-store 248. Further, it is contemplated that the specific product pages 252 are particular to specific partnering brands 112 based on the products being advertised on each page.

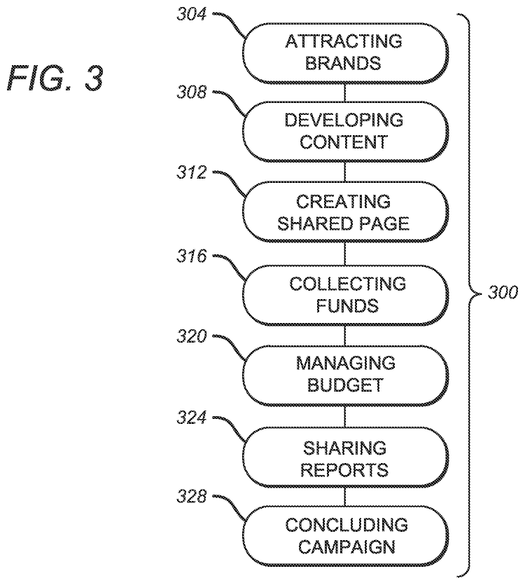

Turning, now, to FIG. 3, a process 300 for managing a collaborative advertising and marketing campaign in accordance with the present disclosure is shown. The process 300 may begin with step 304 wherein a campaign may be posted to attract brands. In some embodiments, the campaign platform administrator 104 may post a campaign brief directed to one or more product types that may be advertised by way of an advertising partnership. For example, the administrator 104 may post a campaign brief describing a brand partnership campaign 108 for eco-friendly kitchen products so as to attract partnering brands 112 that offer products or services related to eco-friendly kitchen products. In one embodiment, for example, the partnering brands 112 may comprise an organic kitchen towel brand, a soap bar brand, and a silicon bags brand. The partnering brands 112 may then enter into a contractual agreement with the administrator 104 and submit their payments, as described herein.

Once participating brands have joined the brand partnership campaign 108, the process 300 advances to a content development step 308. In step 308, an advertising content component 132 (see FIG. 1) may develop production and testing of advertising content pertaining to the brand partnership campaign 108. In an embodiment, for example, the advertising content component 132 may include identifying and contracting a content creator, a creative director, or a production studio to develop advertising content for the campaign. Further, the advertising content component 132 may manage and optimize advertising content across a variety of popular online advertising placements.

In step 312, a hosting component 140 comprising the brand partnership campaign 108 may create a shared landing page may be created for the campaign. The shared landing page may comprise a micro-store that includes a combination of the products pertaining to the brand partnership campaign 108. In an exemplary embodiment, a brand partnership campaign 108 that is related to the above-mentioned eco-friendly kitchen products, the micro-store may include a combination of eco-friendly kitchen products from all of the partnering brands 112, such as organic kitchen towels, eco-friendly soap bars, environmentally friendly silicon bags, and the like. In general, the shared landing page may be a “neutral” page that features products from all the participating partnering brands 112. Further, the hosting component 140 may develop a brand-specific page that includes a dashboard. It is contemplated that the dashboard may be configured to report to each of the partnering brands 112 on the performance of their portion of the brand partnership campaign.

In step 316, the process 300 may advance to collecting funds. As described above, the partnering brands 112 share the cost of operating the brand partnership campaign 108 and consequently their brands will reach more potential customers due to combined media spending. In one embodiment, for example, in step 316 three partnering brands 112 may be directed to make equal payments, such as $50K each, to the administrator 104 to operate the brand partnership campaign 108. Thus, each of the partnering brands 112 will receive $150K worth of advertising exposure for a cost of $50K. It is contemplated that the advertising exposure will generally grow in direct proportion to the number of partnering brands 112 that join the campaign.

Once the partnering brands 112 submit their payments, in step 320 the administrator 104 can direct the partnership platform fee module 124 to direct a small fee, such as 10%, to operate the campaign and direct the remaining funds toward operating the partnership campaign. For example, in one embodiment described in connection with FIG. 1, 80% of the funds is directed to the media management module 120 while 10% of the funds is directed to the campaign content development module 116. Thus, in the above-mentioned embodiment, wherein the three partnering brands 112 each paid $50K, the administrator 104 can direct $120K to the media management module 120 and $15K to the campaign content development module 116.

In some embodiments, in step 320, the media management module 120 (see FIG. 1) may manage the operation of a budgeting component 144 and a campaign optimization component 148. The budgeting component 144 generally manages and directs funding for advertising development and placement. For example, the budgeting component 144 may optimize funding across popular search engines, online advertising placements, and sponsored newsletters, and the like. The campaign optimization component 148 may, in step 324, provide reporting and analytics to the partnering brands 112. The campaign optimization component 148 may collect and compile analytics to report to each of the partnering brands 112 on the performance of their portion of the brand partnership campaign 108. It is contemplated that steps 320 and 324 continue until the process 300 concludes in step 328. As will be appreciated, the process 300 concludes with the brand partnership campaign 108 finishes.

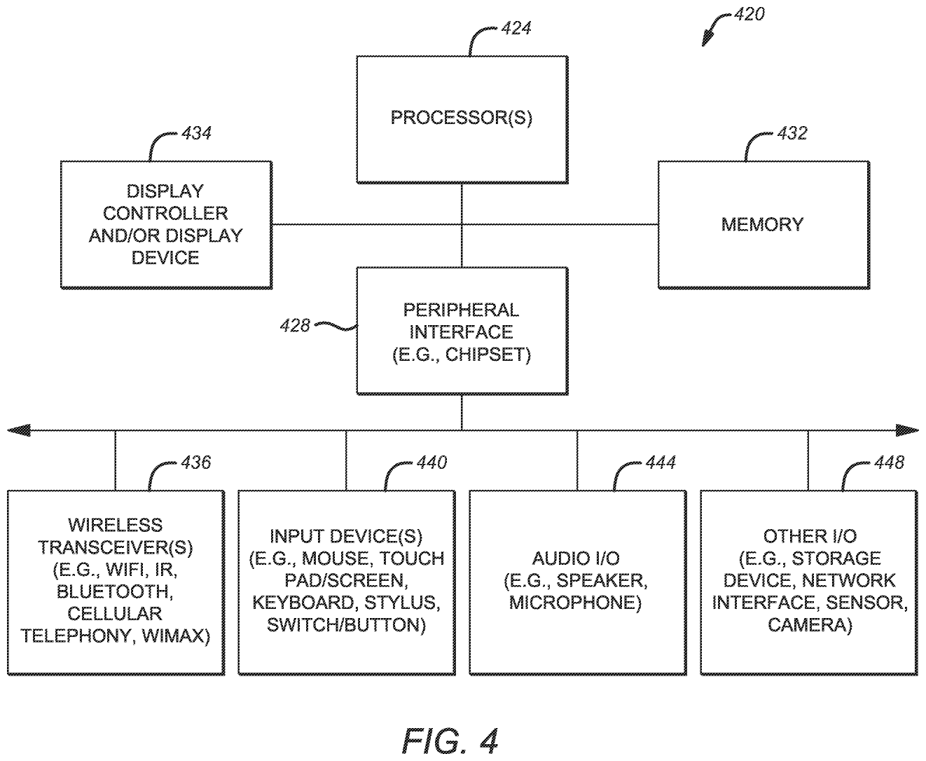

FIG. 4 is a block diagram illustrating an exemplary data processing system 420 that may be used in conjunction with a brand partnership campaign 108 to perform any of the processes or methods described herein. System 420 may represent a desktop, a tablet, a server, a mobile phone, a personal digital assistant (PDA), a personal communicator, a network router or hub, a wireless access point (AP) or repeater, a set-top box, or a combination thereof.

In an embodiment, illustrated in FIG. 4, system 420 includes a processor 424 and a peripheral interface 428, also referred to herein as a chipset, to couple various components to the processor 424, including a memory 432 and devices 436-448 via a bus or an interconnect. Processor 424 may represent a single processor or multiple processors with a single processor core or multiple processor cores included therein. Processor 424 may represent one or more general-purpose processors such as a microprocessor, a central processing unit (CPU), or the like. More particularly, processor 424 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 424 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 424 is configured to execute instructions for performing the operations and steps discussed herein.

Peripheral interface 428 may include a memory control hub (MCH) and an input output control hub (ICH). Peripheral interface 428 may include a memory controller (not shown) that communicates with a memory 432. The peripheral interface 428 may also include a graphics interface that communicates with graphics subsystem 434, which may include a display controller and/or a display device. The peripheral interface 428 may communicate with the graphics device 434 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 424. In such a configuration, the peripheral interface 428 operates as an interface chip performing some functions of the MCH and ICH. Furthermore, a graphics accelerator may be integrated within the MCH or the processor 424.

Memory 432 may include one or more volatile storage (or memory) devices, such as random access memory (RAM), dynamic RAM (DRAM), synchronous DRAM (SDRAM), static RAM (SRAM), or other types of storage devices. Memory 432 may store information including sequences of instructions that are executed by the processor 424, or any other device. For example, executable code and/or data of a variety of operating systems, device drivers, firmware (e.g., input output basic system or BIOS), and/or applications can be loaded in memory 432 and executed by the processor 424. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 428 may provide an interface to IO devices, such as the devices 436-448, including wireless transceiver(s) 436, input device(s) 440, audio IO device(s) 444, and other IO devices 448. Wireless transceiver 436 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 440 may include a mouse, a touch pad, a touch sensitive screen (which may be integrated with display device 434), a pointer device such as a stylus, and/or a keyboard (e.g., physical keyboard or a virtual keyboard displayed as part of a touch sensitive screen). For example, the input device 440 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 444 may include a speaker and/or a microphone to facilitate voice-enabled functions, such as voice recognition, voice replication, digital recording, and/or telephony functions. Other optional devices 448 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 448 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 4 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the collaborative advertising and marketing platform and methods have been described in terms of particular variations and illustrative figures, those of ordinary skill in the art will recognize that the collaborative advertising and marketing platform is not limited to the variations or figures described. In addition, where methods and steps described above indicate certain events occurring in certain order, those of ordinary skill in the art will recognize that the ordering of certain steps may be modified and that such modifications are in accordance with the variations of the collaborative advertising and marketing platform. Additionally, certain of the steps may be performed concurrently in a parallel process, when possible, as well as performed sequentially as described above. To the extent there are variations of the collaborative advertising and marketing platform, which are within the spirit of the disclosure or equivalent to the collaborative advertising and marketing platform found in the claims, it is the intent that this patent will cover those variations as well. Therefore, the present disclosure is to be understood as not limited by the specific embodiments described herein, but only by scope of the appended claims.

1. A brand-specific advertising and marketing platform, comprising:
a campaign server system comprising a non-transient machine-readable medium and at least one processor;
an advertising partnership platform stored on a memory of the campaign server system for operating a brand partnership campaign;
an interface for providing access to partnering brands participating in the brand partnership campaign;
a landing page configured to provide access to a micro-store that includes a combination of the products pertaining to the brand partnership campaign;
a dashboard comprising a graphical user interface to view and access data and analytics pertaining to the performance of the brand partnership campaign;
a database for storing information pertaining to the brand partnership campaign and the partnering brands; and
a suite of brand-specific components providing partnering brands interactivity with the brand partnership campaign.

2. The platform of claim 1, wherein the brand-specific components comprise modules whereby each partnering brand may access and participate in the brand partnership campaign.

3. The platform of claim 2, wherein the brand-specific components include any one or more of performance reports, and advertising placements.

4. The platform of claim 3, wherein the micro-store comprises a shared landing page that includes a combination of the products from all the participating partnering brands.

5. The platform of claim 3, wherein the landing page comprises a page that is specific to each partnering brand and enables the partnering brand to view and interact with its portion of the brand partnership campaign.

6. The platform of claim 3, wherein the dashboard comprises a graphical user interface whereby each partnering brand can view and access analytics pertaining to the performance of the brand partnership campaign.

7. A process for managing a collaborative advertising and marketing campaign, comprising:
attracting partnering brands to participate in a brand partnership campaign;
developing advertising content;
creating a shared landing page configured to provide access to a micro-store that includes a combination of the products pertaining to the brand partnership campaign;
providing a dashboard comprising a graphical user interface to view and access data and analytics pertaining to the performance of the brand partnership campaign;
collecting and compiling analytics to report to the partnering brands;
collecting funds from the partnering brands;
producing reports with partnering brands; and
concluding the brand partnership campaign.

8. The process of claim 7, wherein attracting the partnering brands includes posting a campaign brief directed to one or more product types that may be advertised by way of the brand partnership campaign.

9. (canceled)

10. (canceled)

11. (canceled)

12. (canceled)

13. The process of claim 7, wherein creating a shared landing page further includes developing a brand-specific page directed to each of the partnering brands.

14. The process of claim 7, wherein producing reports includes providing a dashboard to each partnering brand.

15. (canceled)

16. (canceled)

17. The process of claim 7, wherein collecting funds includes directing the partnering brands to make equal payments for the operation of the brand partnership campaign.

18. The process of claim 17, wherein collecting funds includes retaining a small fee for the operation of the brand partnership campaign.

19. The process of claim 18, wherein retaining the small fee includes directing remaining funds toward operating the brand partnership campaign.

20. The process of claim 19, wherein directing the remaining funds includes budgeting funding for advertising development and online advertising placements.
